(19) United States
(12) Patent Application Publication
(10) Pub. No.: US 2018/0244267 A1
(43) Pub. Date: Aug. 30, 2018

(54) METHOD FOR OPERATING A VEHICLE AND DRIVER ASSISTANCE SYSTEM

(71) Applicant: Robert Bosch GmbH, Stuttgart (DE)

(72) Inventor: Burkhard Iske, Leonberg (DE)

(21) Appl. No.: 15/891,077

(22) Filed: Feb. 7, 2018

(30) Foreign Application Priority Data
Feb. 24, 2017 (DE) 102017203036.4

(51) Int. Cl. B60W 30/06; G05D 1/00

(52) U.S. Cl. CPC B60W 30/06; B60W 2420/54; G05D 1/0011

(57) ABSTRACT

A method for operating a vehicle, in particular an autonomously operable vehicle. The vehicle in the state of parking detects the necessity of a driving maneuver and performs the driving maneuver autonomously after the driver has enabled it. Furthermore, a driver assistance system is described for carrying out the method.

### CROSS REFERENCE

The present application claims the benefit under 35 U.S.C. § 119 of German Patent Application No. DE 102017203036.4 filed on Feb. 24, 2017, which is expressly incorporated herein by reference in its entirety.

### FIELD

The present invention relates to a method for operating a vehicle, in particular an autonomously driving vehicle. Furthermore, a driver assistance system is indicated for carrying out the method.

### BACKGROUND INFORMATION

The automation of driving functions is making progress. German Patent Application No. DE 10 2012 200 625 A1 describes an automated parking system, which makes it possible for the driver to let the vehicle park autonomously while the driver is outside the vehicle. For this purpose, the driver must at all times control the driving maneuver via a remote control and bears the responsibility for the driving maneuver. In critical cases, the driver is able to interrupt the maneuver in order to avoid possible damage.

A subsequent step of automation is to remove the driver from the responsibility for the driving maneuver, which is also called highly automated parking. In this instance, the driver activates the maneuver, but is no longer required to monitor it and thus no longer bears the responsibility. It is no longer necessary for the driver to be near the vehicle.

U.S. Pat. No. 9,196,164 B1 describes how autonomously driving vehicles are able to communicate with their surroundings. In this context, the vehicle tells pedestrians that it has detected them and where it will drive. The communication with the surroundings is necessary in particular because visual contact with the driver is no longer possible.

### SUMMARY

The present invention provides for a method for operating a vehicle, the vehicle in the state of parking detecting the necessity of a driving maneuver, and performing the parking maneuver autonomously after the driver has enabled the parking maneuver, the vehicle detecting the necessity of the driving maneuver on the basis of acoustic information.

According to one specific embodiment, a state of parking is understood as that the vehicle is parked. Typically, it is locked in this instance, and no occupant is inside the vehicle. The hand brake is typically engaged in this instance. According to another specific embodiment, a state of parking is understood as that the vehicle is on the way to a parking space, the vehicle possibly driving a route to the parking space autonomously and then performing the parking process autonomously. In all cases, the driver moved away from the vehicle and communicates with the vehicle from a distance. One advantage of the method is that it is not necessary for the driver of the autonomously driving vehicle to return to the vehicle in order to perform the driving maneuver.

In the context of the present disclosure, an autonomous performance of the driving maneuver is understood as that the vehicle performs the driving maneuver autonomously as far as longitudinal and lateral guidance are concerned, i.e., the vehicle steers and accelerates by itself. It is preferably provided that the vehicle also calculates the travel trajectory of the driving maneuver autonomously. The travel trajectory is typically formed by one or multiple trajectory segments, which are e.g. selected from a set of discrete geometrical elements such as straight-line segments, curve segments and clothoid segments.

The driving maneuver is carried out autonomously by a driver assistance system of the vehicle. Preferably, however, it is provided that the vehicle is able to receive external control commands while performing the driving maneuver, so that the driver is able to perform corrections from a distance or avert dangerous situations. The control may also be performed by persons near the vehicle.

The vehicle detects the necessity of the driving maneuver on the basis of acoustic information, in particular voice commands. This type of communication is particularly expedient because it is a natural form of communication. Voice commands may be communicated to the autonomously driving vehicle by parking lot attendants, pedestrians or other drivers. For this purpose, there may be a provision for example that the detection of the necessity of a driving maneuver is triggered by a code word.

There may be a provision for the vehicle to communicate in return by voice while performing the maneuver, i.e., for example to inform the parking lot attendant, the pedestrians or other drivers by voice outputs that they were detected and where the vehicle will drive. Furthermore, the driver may communicate in return the authorization or the non-authorization of the driving maneuver.

The driving maneuver preferably comprises a reparking or a maneuvering of the vehicle. Reparking in this context refers to a movement of the vehicle from a first parking space to a second parking space. Maneuvering in this context refers to a temporary movement from a first parking space to a free position in order later to return to the first parking space, e.g., after another vehicle has passed a narrow spot bounded by the first parking space.

If during the reparking process a better parking space is freed while driving from the starting point to the destination, it is possible to vary the maneuver quickly.

The method is carried out for example in a parking lot. A “parking lot” here refers to a parking space for multiple vehicles as contrasted with the term “parking space” of the vehicle. The parking lot may be for example a parking garage. Alternatively, the parking lot may be an underground parking facility. The parking lot may extend over several stories or may be on one level. It may be for example an area in front of a supermarket, in front of a zoo, in front of a stadium or the like.

The method may be performed during so-called valet parking. For this purpose, the driver parks the vehicle in a provisional parking space, and the parking attendant guides the vehicle by voice commands to the destination parking space. According to the present invention, the driving maneuver is performed autonomously after the driver has enabled it.

The driver of the vehicle preferably receives a message that the driving maneuver is necessary. According to one specific embodiment, the message with the driving maneuver information for the driver merely contains the message that an external guidance of the vehicle, possibly limited in time, by a present person using voice commands or an additional remote control is to be performed. Alternatively, the message with the driving maneuver information for the driver includes a destination indication of the new parking space, represented graphically, for example, and/or with an indication of the distance from the current parking space. In the case of a parking garage, the destination indication may also include for example the indication of the parking space number, the parking level etc. In other developments, drivers are able to select free parking spaces in the surroundings of the vehicle.

By way of another message, the driver enables the driving maneuver, e.g., by simple confirmation. If the driver does not enable the driving maneuver, then no driving maneuver is performed. Not enabling the driving maneuver may be achieved in that the driver does not respond or that the enabling is actively denied.

The present invention additionally provides a driver assistance system of a vehicle, including a monitoring module, which is designed to detect, in the state of parking, the necessity of a driving maneuver by receiving and analyzing acoustic information; a vehicle-side communication module, which is designed to ask the driver of the vehicle to enable the driving maneuver if the necessity of a driving maneuver has been detected; an external communication module, which is connected to the vehicle-side communication module in order to communicate with the latter; and a driving module, which is designed to perform the driving maneuver autonomously after the driver has enabled it.

The driver assistance system is preferably designed and/or set up to carry out the methods described herein. Accordingly, the features described in connection with the methods shall count as disclosed with respect to the driver assistance system, and vice versa the features described in connection with the driver assistance system shall count as disclosed with respect to the methods.

The monitoring module comprises means for receiving and analyzing acoustic information, in particular in the form of voice commands. The means comprise for example one or multiple microphones and a voice-recognition software. For the voice-recognition software, it is possible for example to re-utilize the software of a module that receives voice commands in the interior of the vehicle.

The vehicle-internal communication module is connected to the external communication module and is able to control for example a display on a mobile device that has the external communication module or is able to transmit a voice message or even to conduct a dialog with the driver.

In one specific embodiment, the external communication module is a communication module of a mobile device, for example a laptop, smart phone, tablet, a wearable or a smart watch. The mobile device preferably has a communication module with push-message function, particularly preferably with a direct response function.

The external communication module has an input unit, by which the driver is able to authorize or reject the maneuver. The input unit may comprise a voice interface and/or a touch-sensitive interface, but may also be controllable by input devices such as pens or the like.

The communication protocol between the vehicle and the driver is in principle arbitrary, but it preferably comprises an encryption of the communication.

The communication may occur via Internet, LAN, W-LAN, mobile telephony network etc.

The vehicle is preferably equipped with additional surroundings detection devices and communication devices. The surroundings detection devices of the vehicle are able to detect and interpret the surroundings of the vehicle and ideally additional metainformation regarding these surroundings. Surroundings detection devices may be cameras built into the vehicle, an ultrasonic system, a radar system and/or a LIDAR system. The detected and interpreted vehicle surroundings may be communicated to the driver, e.g., as a decision-making aid. The surroundings detection device is preferably already in production use as part of a parking assistance system.

The present invention also comprises the corresponding subsystems for use in one of the described driver assistance systems, namely, the vehicle-side subsystem, having the appropriately set up monitoring module, the vehicle-side communication module and driving module, as well as the external subsystem having the external communication module.

The present invention also comprises computer programs, comprising commands that prompt one of the previously described driver assistance systems or subsystems to perform the corresponding steps of one of the previously described methods. The computer program may be for example modules for implementing the driver assistance system or a subsystem of the latter in a vehicle or on a mobile device.

The present invention also comprises a computer-readable medium, on which the computer program is stored. The computer program may be stored for example on a permanent or rewritable storage medium, on a CD-ROM, DVD, Blu-ray disc or USB stick. Additionally or alternatively, the computer program may be provided on a computer device such as a server or a cloud computing system for download, e.g., via a data network such as the Internet or a communication link such as a telephone line or a wireless link.

In accordance with the present invention, in addition to the passing on of information of the autonomous vehicle regarding its intentions to the surroundings such as described for example in U.S. Pat. No. 9,196,164 B1, the communication between the surroundings and the vehicle becomes relevant. If an autonomously driving vehicle in the parking state is involved in a so-called deadlock traffic situation, i.e., jammed traffic situation, it is possible to communicate to the vehicle via voice commands where it should drive in order to resolve the deadlock situation.

An advantage is that the driver of the parking vehicle does have to return to the vehicle in order to resolve the situation. The driver merely receives a corresponding message on his smartphone in order to enable the requested action.

For vehicles that have a microphone, the present invention has another application, an additional use case.

### BRIEF DESCRIPTION OF THE DRAWINGS

Exemplary embodiments of the present invention are shown in the figures and are explained in more detail below.

FIG. 1 shows a parking lot including a deadlock situation.

### DETAILED DESCRIPTION OF EXAMPLE EMBODIMENTS

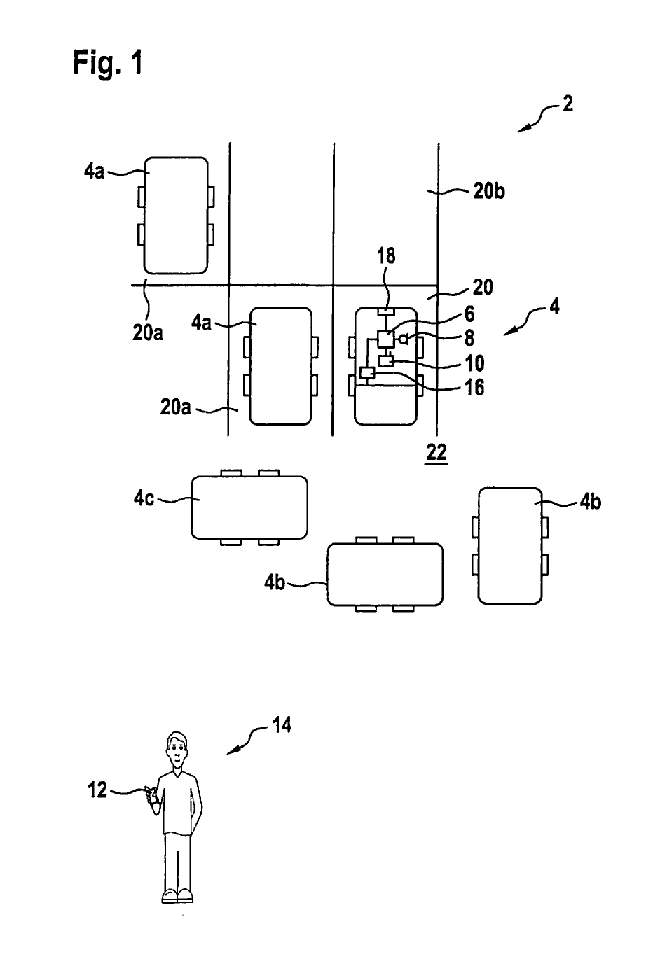

FIG. 1 shows a vehicle 4 equipped in accordance with the present invention and parked in a parking lot 2.

The vehicle 4 equipped in accordance with the present invention has a driver assistance system 6, which comprises typical hardware components such as processing units, memory units, bus systems and communication interfaces. Driver assistance system 6 also comprises a monitoring module 8, which is designed to detect, in the state of parking, the necessity of a parking maneuver. In the specific embodiment shown, monitoring module 8 comprises for this purpose a microphone, which records the sounds of the surroundings. Monitoring module 8 furthermore comprises voice recognition software for evaluating the acoustic information of the microphone.

Driver assistance system 6 furthermore comprises a vehicle-side communication module 10, which is functionally connected to monitoring module 8 and is designed to ask driver 14 of vehicle 4 to enable the driving maneuver when the necessity of a driving maneuver is detected.

For this purpose, vehicle-side communication module 10 communicates with an external communication module 12, which driver 14 carries with him. Within the scope of the present disclosure, external communication module 12 is considered as part of driver assistance system 6.

After parking vehicle 4, which is equipped in accordance with the present invention, driver 14 is no longer in its proximity, typically also no longer in visual range. The communication of vehicle-side communication module 10 with external communication module 12 occurs for example via an Internet connection. External communication module 12 may be developed as a communication module of a mobile device.

Driver assistance system 6 furthermore comprises a driving module 16, which is designed to initiate a autonomous performance of the driving maneuver after driver 14 has enabled it. For this purpose, driving module 16 in a known manner takes over the acceleration, braking and steering of the vehicle 4 equipped in accordance with the present invention.

Vehicle 4 equipped in accordance with the present invention also comprises a surroundings detection device 18, which comprises for example ultrasonic sensors, radar sensors, cameras or LIDAR sensors. Surroundings detection device 18, like the other components of driver assistance system 6, may be used in other driver assistance applications such as, e.g., for blind spot detection, speed or lane assistance, parking assistance, etc.

Vehicle 4 equipped in accordance with the present invention is parked in parking lot 2 in a first parking space 20.

Additional vehicles 4a are parked in additional parking spaces 20a in parking lot 2.

In the situation depicted, two incorrectly parked vehicles 4b form a narrow spot with vehicle 4 equipped in accordance with the present invention. A vehicle 4c driving is unable to pass narrow spot 22.

The additional driver of the passing vehicle 4c requests that vehicle 4 equipped in accordance with the present invention maneuvers so as to free the narrow spot temporarily.

Monitoring module 8 of vehicle 4 equipped in accordance with the invention detects the voice command of the additional driver of passing vehicle 4c to free narrow spot 22 temporarily and transmits a query to driver 14 via vehicle-side communication module 10. After the driver has enabled the driving maneuver, vehicle 4 equipped in accordance with the invention maneuvers autonomously, i.e. it allows vehicle 4c to pass and returns to its parking space 20.

In an alternative specific embodiment, the additional driver of the passing vehicle 4c requests that vehicle 4 equipped in accordance with the invention repark in order to free narrow spot 22 permanently. Monitoring module 8 of vehicle 4 equipped in accordance with the present invention detects the voice command of the additional driver of passing vehicle 4c to repark and transmits a query to driver 14 via vehicle side communication module 10. After driver 14 has enabled the driving maneuver, vehicle 4 equipped in accordance with the present invention reparks autonomously, e.g. to the free parking space 20b nearby.

The present invention is not restricted to the exemplary embodiments described here and the aspects emphasized therein. Instead, a multitude of variations that lie within the scope of the actions of one skilled in the art are possible within the framework described herein.

What is claimed is:

1. A method for operating a vehicle, the method comprising:
detecting, by the vehicle while the vehicle is in a state of parking, the necessity of a driving maneuver; and
performing the driving maneuver autonomously after the driver has enabled the driving maneuver, the vehicle detecting the necessity of the driving maneuver on the basis of acoustic information.

2. The method as recited in claim 1, wherein a message is transmitted to the driver of the vehicle that the driving maneuver is necessary and that the driver should enable the driving maneuver via another message.

3. The method as recited in claim 1, wherein the driving maneuver comprises one of a reparking of the vehicle or maneuvering of the vehicle.

4. The method as recited in claim 1, wherein the method is performed in a parking lot.

5. A driver assistance system of a vehicle, comprising:
a monitoring module designed, in a state of parking, to detect the necessity of a driving maneuver by receiving and evaluating acoustic information;
a vehicle-side communication module designed to ask the driver of the vehicle to enable the driving maneuver when the necessity of a driving maneuver has been recognized;
an external communication module connected to the vehicle-side communication module in order to communicate with the vehicle-side communication module; and
a driving module designed to perform the driving maneuver autonomously after the driver has enabled it.

6. The driver assistance system as recited in claim 5, wherein the external communication module is a communication module of a mobile device.

7. The driver assistance system as recited in claim 5, further comprising a vehicle-side subsystem.

8. The driver assistance system as recited in claim 5, further comprising an external subsystem.

9. A non-transitory computer-readable medium on which is stored a computer program for operating a vehicle, the computer program, when executed by a processor, causing the processor to perform:
detecting, by the vehicle while the vehicle is in a state of parking, the necessity of a driving maneuver; and
performing the driving maneuver autonomously after the driver has enabled the driving maneuver, the vehicle detecting the necessity of the driving maneuver on the basis of acoustic information.
